(19) United States
(12) Patent Application Publication
(10) Pub. No.: US 2023/0186355 A1
(43) Pub. Date: Jun. 15, 2023

(54) METHODS AND SYSTEMS FOR OPERATING A MOTOR VEHICLE HAVING A TRACTION BATTERY CHARGEABLE FROM A SUPPLY NETWORK, COMPUTER PROGRAM PRODUCT FOR A MOTOR VEHICLE OF THIS TYPE, COMPUTER PROGRAM PRODUCT FOR A CLOUD, AND MOTOR VEHICLE AND CLOUD FOR A SYSTEM OF THIS TYPE

(71) Applicant: Ford Global Technologies, LLC, Dearborn, MI (US)

(72) Inventors: Markus Espig, Aachen (DE); David van Bebber, Aachen (DE)

(73) Assignee: Ford Global Technologies, LLC, Dearborn, MI (US)

(21) Appl. No.: 18/063,392

(22) Filed: Dec. 8, 2022

(30) Foreign Application Priority Data
Dec. 13, 2021 (DE) 102021132826.8

(51) Int. Cl. G06Q 30/04; B60L 53/66

(52) U.S. Cl. CPC G06Q 30/04; B60L 53/665

(57) ABSTRACT

The disclosure relates to a method for operating a motor vehicle having a traction battery chargeable from a supply network, that includes loading a position dataset indicative of a present position of the motor vehicle, loading a charging dataset indicative of a quantity of electricity charged into the traction battery of the motor vehicle, determining a position of the motor vehicle by evaluating the position dataset, and assigning the determined position to a charging point.

### CROSS-REFERENCE TO RELATED APPLICATIONS

The applications claims priority to and the benefit of German Application No. 102021132826.8, filed Dec. 13, 2021, which is hereby incorporated by reference herein in its entirety.

### FIELD OF THE INVENTION

The disclosure relates to methods and systems for operating a motor vehicle having a traction battery chargeable from a supply network.

### BACKGROUND

Motor vehicles having a traction battery chargeable from a supply network can be electric vehicles (BEV) having a powertrain which has exclusively only one or more electric motors. They can also be plug-in hybrid vehicles (PHEV) whose powertrain has a combination of an electric motor and an internal combustion engine.

Charging points at charging stations for cost-free charging and/or having graduated, in particular reduced, electricity tariffs for traction batteries of motor vehicles having a traction battery chargeable from a supply network are made available, e.g., to employees by the employer on company parking lots. Furthermore, charging stations of this type can also be made available e.g. to customers on parking lots of a department store or supermarket.

In addition, a motor vehicle of this type can also be charged at the place of residence of the driver, e.g. in a garage by means of a wallbox and/or on a different charging station also, subject to a fee.

Methods and/or devices for supporting charging procedures of this type are known, for example, from CA 2 950 680 A1, U.S. Pat. No. 10,023,063 B2, US 2020/0055415 A1 and KR 2015 0080126 A, wherein it is known from CA 2 950 680 A1, U.S. Pat. No. 10,023,063 B2 and US 2020/0055415 A1 for navigation data, such as GPS data, to be taken into account.

However, there is a need to find ways to record and log charging procedures at charging points for cost-free charging and/or with graduated, in particular reduced, electricity tariffs.

### SUMMARY

An object of the disclosure is achieved by a method for operating a motor vehicle having a traction battery chargeable from a supply network, having the steps of:
loading a position dataset indicative of a present position of the motor vehicle,
loading a charging dataset indicative of a quantity of electricity charged into the traction battery of the motor vehicle,
determining a position of the motor vehicle by evaluating the position dataset, and
assigning the determined position to a charging point.

The position dataset can be determined and provided from a navigation system of the motor vehicle, such as, for example, a GPS, whereas the charging dataset can be determined and provided from a battery management system (BMS) for controlling the traction battery of the motor vehicle.

The current position of the motor vehicle can be determined at a charging point by evaluating the position dataset and, due to the stationary arrangement of the charging point, the latter can then be uniquely identified on the basis of its position.

In particular, by determining the present position of the motor vehicle at a charging point and by evaluating the position, it is possible to establish whether costs are incurred at this charging point for charging the traction battery and, if so, in what amount. Charging procedures can thus be captured and logged at charging points for cost-free charging and/or with graduated, in particular reduced, electricity tariffs.

According to one embodiment, the method has the following further step:
determining a billing dataset using an accounting dataset which is assigned to the determined charging point.

Thus, insofar as costs are incurred for charging the traction battery at the charging point, a billing dataset can be created which can be communicated e.g. to a mobile device, such as a smart phone, of a driver of the motor vehicle. Alternatively or additionally, the billing dataset can also be communicated to different locations, such as, for example, a fleet management service provider, or can be temporarily stored in order to be read later for evaluation purposes. Finally, the billing dataset can also be used for automated billing, i.e. for electronic payment or electronic payment processing. Billing procedures can thus be simplified and/or automated.

According to a further embodiment, at least one of the steps of:
determining the position of the motor vehicle by evaluating the position dataset, and/or
assigning the determined position to a charging point, and/or
determining a billing dataset using an accounting dataset,
can be carried out in a cloud.

A cloud is understood to mean a computer or a computer network with a plurality of computers, including associated processors, providing computer resources as a service, e.g., in the form of servers, data memories or applications Data, such as, for example, the position dataset and/or charging dataset, are transmitted wirelessly to the cloud, are processed there, and the result, e.g., in the form of the billing dataset, is again transmitted wirelessly to the mobile device of the driver. Computer resources of the motor vehicle, in particular, can thus be conserved.

The disclosure further includes a system for operating a motor vehicle, a first computer program product for a motor vehicle, a second computer program product for a cloud, and a motor vehicle and a cloud for a system of this type.

### BRIEF DESCRIIPTION OF THE DRAWINGS

The disclosure will now be explained with reference to a drawing. In the drawing:

FIG. 1 shows a schematic view of components of a system for operating a motor vehicle having a traction battery chargeable from a supply network.

FIG. 2 shows a schematic view of a method sequence for operating the system shown in FIG. 1.

### DETAILED DESCRIPTION

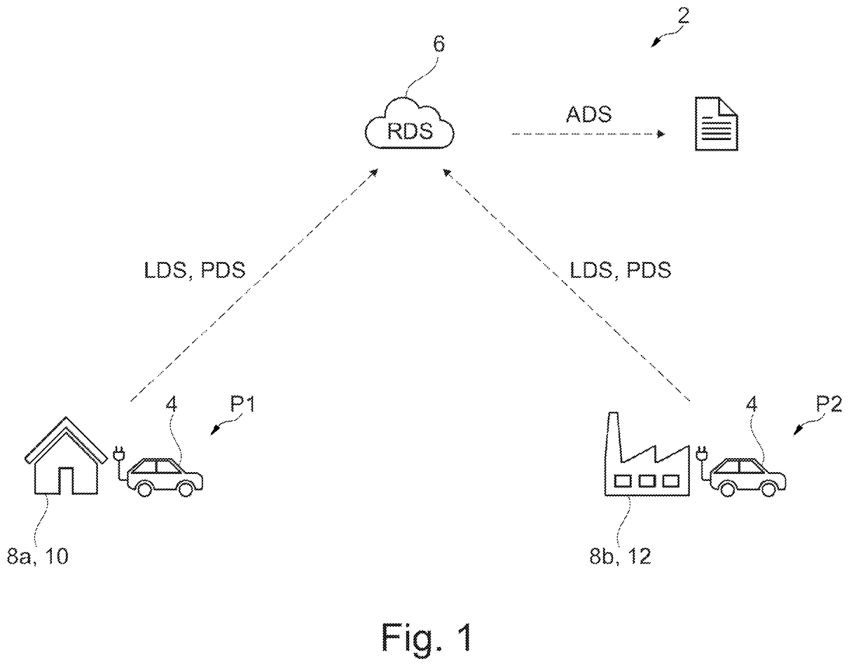

Reference is first made to FIG. 1.

A system 2 for operating a motor vehicle 4 is shown.

In the present exemplary embodiment, the motor vehicle 4 is designed as a passenger vehicle. In the present exemplary embodiment, the motor vehicle 4 is further designed as an electric vehicle (BEV) or as a plug-in hybrid (PHEV) having a traction battery chargeable from a supply network.

In the present exemplary embodiment, along with the motor vehicle 4, the system 2 includes a cloud 6, a charging point 8a for charging the traction battery of the motor vehicle 4 at the place of residence 10 of the driver of the motor vehicle 4, and a charging point 8b at the location of the employer 12 of the driver of the motor vehicle 4.

The system 2, the motor vehicle 4, the cloud 6 and the charging points 8a, 8b can in each case have hardware and/or software components for the tasks and/or functions respectively described below.

FIG. 1 therefore shows two scenarios alongside one another. In the first scenario, the traction battery of the motor vehicle 4 is charged with the charging point 8a at the place of residence 10 of the driver, whereas, in the second scenario, the traction battery of the motor vehicle 4 is charged with the charging point 8b at the location of the employer 12 of the driver. The motor vehicle 4 is correspondingly located e.g. in a garage or in a carport in the first scenario, whereas the vehicle 4 is located e.g. on a company parking lot in the second scenario.

In the present exemplary embodiment, the charging points 8a, 8b in each case provide a single charging point. A charging point is understood to mean an interface with which only the traction battery of one motor vehicle 4 can be charged at one time.

In the present exemplary embodiment, the charging points 8a, 8b are designed as charging stations, such as, for example, wall-mounted charging stations (also referred to as wallboxes). A wall-mounted charging station of this type is understood to mean a charging station for electric vehicles or plug-in hybrids which is provided for attachment to a wall. The charging points 8a, 8b in each case provide a connection of the motor vehicle 4 to the supply network, perform the communication with a battery management system of the motor vehicle 4, e.g., for the available current intensity, and can also provide further functions. In contrast to the present exemplary embodiment, the charging points can also be designed e.g. as charging poles, e.g. having the same functional scope.

In the present exemplary embodiment, the cloud 6 is designed for wireless data exchange with the motor vehicle 4 and/or the charging stations 8a, 8b.

In the present exemplary embodiment, the data to be transmitted comprise a position dataset PDS indicative of a present position of the motor vehicle 4 and a charging dataset LDS indicative of a quantity of electricity charged into the traction battery of the motor vehicle 4. In addition, it can be provided to transmit further data, such as, for example, timestamp data, indicative of the start and end of the charging procedure of the traction battery of the motor vehicle 4.

In the present exemplary embodiment, the position dataset PDS is determined and provided from a navigation system of the motor vehicle 4, such as, for example, a GPS, whereas, in the present exemplary embodiment, the charging dataset LDS is determined and provided from a battery management system (BMS) for controlling the traction battery of the motor vehicle 4.

In the present exemplary embodiment, the cloud 6 is designed to load the position dataset PDS and the charging dataset LDS, to determine a present position P1, P2 of the motor vehicle 4 by evaluating the position dataset PDS, and to assign the determined position P1, P2 to one of the charging points 8a, 8b. Information indicating the charging station 8a, 8b at which the traction battery of the motor vehicle 4 is charged is thus provided.

In the present exemplary embodiment, the cloud 6 is further designed to determine a billing dataset ADS using an accounting dataset RDS. The accounting dataset RDS is assigned to the determined charging point 8a, 8b and contains e.g. data relating to electricity tariffs of the determined charging point 8a, 8b. The accounting dataset RDS can also contain data indicating that cost-free charging and/or charging with graduated, in particular reduced, electricity tariffs is possible at the determined charging point 8a, 8b, such as at the charging point 8b according to the second scenario e.g. on a company parking lot.

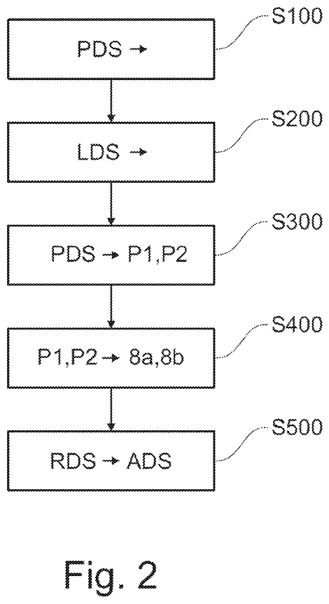

Reference will now be made additionally to FIG. 2 in order to explain a method sequence for operating the system 2.

The method starts with a first step S100 after e.g. the driver has set up an electrically conducting connection between the motor vehicle 4 and one of the charging points 8a, 8b in order to charge the traction battery of the motor vehicle 4.

In the first step S100, the position dataset PDS is loaded after it has been determined.

In a further step S200, the charging dataset LDS is loaded after it has similarly been loaded.

The first step S100 can be carried out, e.g., at the start of the charging procedure, whereas the further step S200 can only be carried out on completion of the charging procedure. In this case, the position dataset PDS and the charging dataset LDS are transmitted in succession separately from one another. Alternatively, steps S100 and S200 can also be carried out on completion of the charging procedure. In this case, the position dataset PDS and the charging dataset LDS can be combined into a total dataset and then transmitted.

In a further step S300, the position P1, P2 of the motor vehicle 4 at one of the charging points 8a, 8b is determined by evaluating the position dataset PDS.

In a further step S400, the determined position P1, P2 is assigned to one of the charging points 8a, 8b.

In a further step S500, the billing dataset ADS is determined using an accounting dataset RDS which is assigned to the determined charging point 8a, 8b.

According to the present exemplary embodiment, steps S100 and S200 are carried out in the motor vehicle 4, whereas steps S300, S400 and S500 are carried out in the cloud 6. However, In contrast to the present exemplary embodiment, step S300 or steps S300 and S400 or steps S300, S400 and S500 can also be carried out in the motor vehicle 4 and not in the cloud 6.

Furthermore, in contrast to the present exemplary embodiment, the sequence of the steps can also be different. A plurality of steps can furthermore also be carried out concurrently or simultaneously. Furthermore, also in contrast to the present exemplary embodiment, individual steps can be skipped or omitted.

In particular, by determining the present position P1, P2 of the motor vehicle 4 at a charging point 8a, 8b and by evaluating the position P1, P2, it is thus possible to establish whether costs are incurred at this charging point 8a, 8b for charging the traction battery and, if so, in what amount, e.g. according to graduated electricity tariffs. Charging procedures at charging points 8a, 8b for cost-free charging can thus be captured and logged.

### REFERENCE NUMBER LIST

2 System

4 Motor vehicle

6 Cloud

8a Charging point

8b Charging point

10 Place of residence

12 Employer

P1 Position

P2 Position

ADS Billing dataset

LDS Charging dataset

PDS Position dataset

RDS Accounting dataset

S100 Step

S200 Step

S300 Step

S400 Step

S500 Step

What is claimed is:

1. A method for operating a motor vehicle having a traction battery chargeable from a supply network, having the steps of:
loading a position dataset indicative of a present position of the motor vehicle,
loading a charging dataset indicative of a quantity of electricity charged into the traction battery of the motor vehicle,
determining a position of the motor vehicle by evaluating the position dataset, and
assigning the determined position to a charging point.

2. The method according to claim 1, having a further step of:
determining a billing dataset using an accounting dataset which is assigned to the determined charging point.

3. The method according to claim 1, wherein at least one of the steps of:
determining the position of the motor vehicle by evaluating the position dataset,
assigning the determined position to a charging point, or
determining a billing dataset using an accounting dataset, is carried out in a cloud.

4. The method of claim 1, having a further step of establishing whether cost is incurred at this charging point for charging the traction battery.

5. The method of claim 4, having a further step of determining an amount of the cost.

6. The method of claim 5, having a further step of determining billing dataset based on an accounting dataset.

7. A computer program product for a cloud, designed to carry out the method of claim 1.

8. A system for operating a motor vehicle having a traction battery chargeable from a supply network, wherein the system is designed to:
load a position dataset indicative of a present position of the motor vehicle,
load a charging dataset indicative of a quantity of electricity charged into the traction battery of the motor vehicle,
determine a position of the motor vehicle by evaluating the position dataset, and
assign the determined position to a charging point.

9. The system according to claim 8, wherein the system is designed to determine a billing dataset using an accounting dataset, wherein the accounting dataset is assigned to the determined charging point.

10. The system according to claim 8, wherein the system has a cloud which is designed to determine at least one position of the motor vehicle by evaluating the position dataset and/or to assign the determined position to a charging point and/or to determine a billing dataset using an accounting dataset.
